(19) United States
(12) Patent Application Publication
(10) Pub. No.: US 2018/0158383 A1
(43) Pub. Date: Jun. 7, 2018

(54) INTERACTIVE ADVERTISING DISPLAY FOR SCREEN PROTECTORS

(71) Applicant: Gregory Blair Norris, Sandy, UT (US)

(72) Inventor: Gregory Blair Norris, Sandy, UT (US)

(21) Appl. No.: 15/370,991

(22) Filed: Dec. 6, 2016

(51) Int. Cl. G09F 19/10; G09B 25/00

(52) U.S. Cl. CPC G09F 19/10; G09B 25/00

(57) ABSTRACT

An interactive advertising display for allowing a user to test the advertised strength of a glass screen protector for a mobile electronic device. The display includes a striker mounted to a backboard. A mounting assembly secures the striker to the backboard such that the striker is operable between a lowered position and a raised position. Pre-positioned to receive a blow from the striker is a glass screen protector for a mobile electronic device. In operation, the user manually lifts the striker from the lowered position to the raised positioned. When released by the user, the striker free falls from the raised position and impacts the glass screen protector. In this manner, the user may test the advertised strength of the glass screen protector using the interactive advertising display.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

### 1. The Field of the Invention

The present invention relates generally to advertising displays and more particularly, but not necessarily entirely, advertising displays for screen protectors utilized on mobile electronic devices, such as smart phones.

### 2. Description of Related Art

Advertising displays are designed to increase sales. Often times, advertising displays include signage promoting the features of the products being offered for sale. In the case of screen protectors for use on mobile electronic devices, manufactures often tout in signage or on the product packaging the ability of their screen protectors to withstand impacts. While these types of advertising displays are effective, it would be an advantage over the prior art to provide an interactive advertising display that actually allows consumers to test a manufacturer's claims regarding the ability of its screen protectors to protect a screen of a mobile electronic device from impacts.

The features and advantages of the invention will be set forth in the description which follows, and in part will be apparent from the description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of an interactive advertising display for a screen protector with a striker in a lowered position according to an embodiment of the present disclosure;

FIG. 2 is a perspective view of the interactive advertising display shown in FIG. 1 with the striker in a raised position;

FIG. 3 is an exploded view of the interactive advertising display shown in FIG. 1;

FIG. 4 is a perspective view of a mounting bracket for a striker according to an embodiment of the present disclosure;

FIG. 5 is a side view of the mounting bracket shown in FIG. 4;

FIG. 6 is a rear view of the mounting bracket shown in FIG. 4;

FIG. 7 is a cross-sectional view of the mounting bracket shown in FIG. 4; and

FIG. 8 depicts an interactive advertising display in a stand-alone configuration.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “containing,” “characterized by,” “having,” and grammatical equivalents thereof are inclusive or open-ended terms that do not exclude additional, unrecited elements or method steps.

As used herein, the term “screen protector” refers to a thin sheet of transparent, or semi-transparent material that is applied over the display of a mobile electronic device. Screen protectors may be formed of glass, tempered glass, films, and plastic films.

It is objective of the present disclosure to provide an interactive advertising display that allows users to test the advertised benefits of screen protectors for mobile electronic devices. In an embodiment, the screen protectors are glass screen protectors, tempered glass screen protectors, film screen protectors. In an embodiment, mobile electronic devices include smart phones, digital music players, tablets, e-readers, and any other mobile electronic device with an electronic display.

It is still another objective of the present disclosure to provide an interactive advertising display with a striker that is raised by a user and then released to strike a glass screen protector.

It is still another objective of the present disclosure to provide an interactive advertising display with a mounting assembly for pivotally mounting a striker to a back support member such that the striker swings between a first position and a second position.

It is still another objective of the present disclosure to provide an interactive advertising display for testing the impact resistance of an object made of glass, such as a glass screen protector or the display of a mobile electronic device.

It is still a further object of the present disclosure to provide an interactive advertising display for demonstrating the impact resistance of a glass screen protector, wherein the display utilizes an off-the-shelf hammer pivotally mounted to a structure.

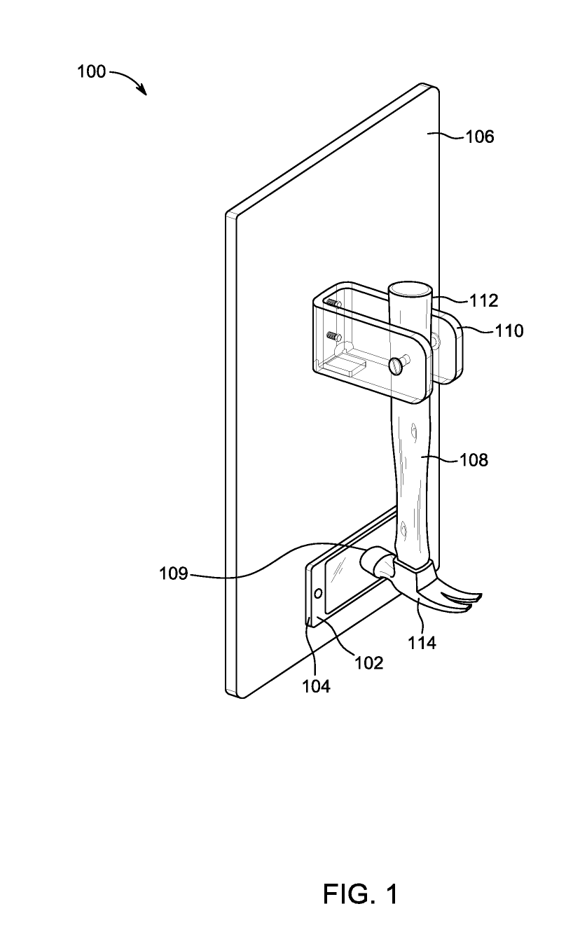

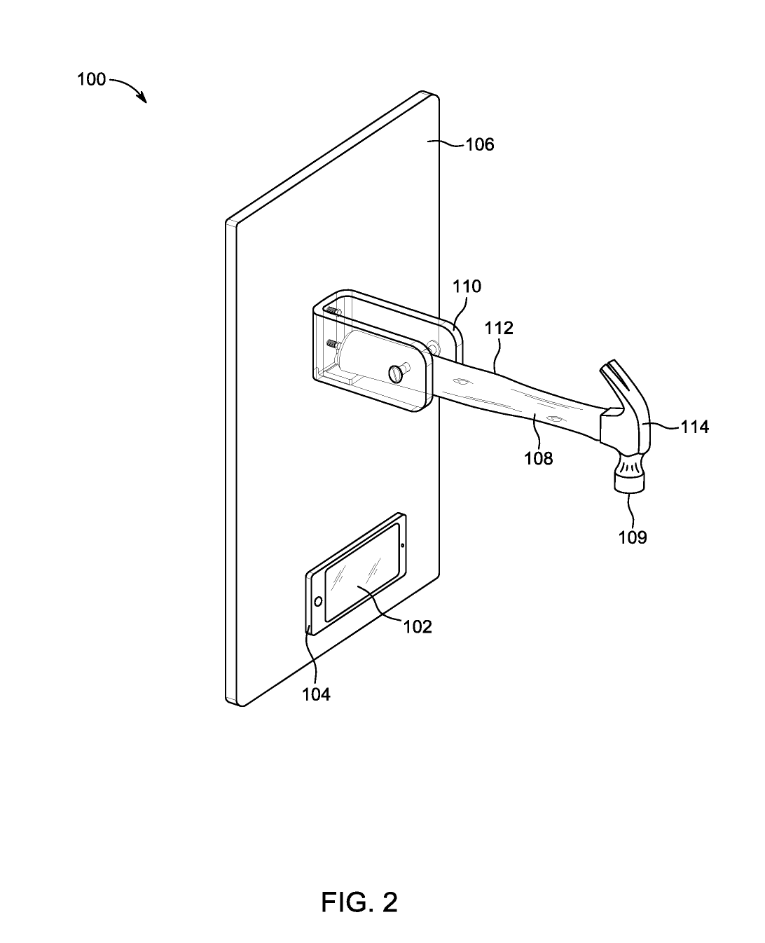

Referring now to FIGS. 1 and 2, there is depicted an interactive advertising display 100 for a screen protector 102 for a mobile electronic device 104 according to an embodiment of the present disclosure. In an embodiment, the display 100 comprises a back support member 106. It will be appreciated that the back support member 106 may be formed of any suitable material, including, without limitation, one of plastic, wood and metal. The back support member 106 may be rectangular or some other shape. In an embodiment, the back support member 106 may be secured to a vertical structure, such as a wall.

In an embodiment, the screen protector 102 is installed on the mobile electronic device 104. The mobile electronic device 104, in turn, is mounted to the back support member 106. The device 104 may be mounted to the back support member 106 in any manner, including using one of fasteners, hook and loop fasteners, adhesive, brackets, tape, and magnets. It will be appreciated that the mobile electronic device 104 may be a non-functional replica as its only purpose is to show the use of the screen protector 102. In an embodiment, the mobile electronic device 104 is omitted altogether and the screen protector 102 is mounted directly to the back support member 106 using any of the aforementioned techniques. In an embodiment, the screen protector 102 is mounted to a block, model, replica, reproduction, simulation, or likeness of a mobile electronic device that is in turn mounted to the back support member 106.

A striker 108 is mounted to the back support member 106 using a striker mounting assembly 110. In an embodiment, the striker 108 comprises an impact surface 109 configured, adapted and positioned to strike the screen protector 102. In this regard, the screen protector 102 is secured to the back support member 106 in a fixed relationship to the striker 108. It will be appreciated that the striker 108 is any device or thing that is capable of delivering a strike or impact to the screen protector 102. In an embodiment, the striker 108 comprises an elongated arm 112 having a head 114. In an embodiment, the striker 108 is an off-the-shelf hammer with a metal head.

The striker 108 may be user operated between a lowered position as shown in FIG. 1 and a raised position as shown in FIG. 2. In this regard, the striker 108 may swing between the lowered position and the raised position. For example, in operation, a user may raise the striker 108 from the lowered position as shown in FIG. 1 to the raised position as shown in FIG. 2. Once the striker 108 has been operated to the raised position, the user may release the striker 108 such that it free falls to the lowered position and, in the process, strikes the screen protector 102. In this manner, a user is able to interactively test the strength of the screen protector 102 utilizing the display 100.

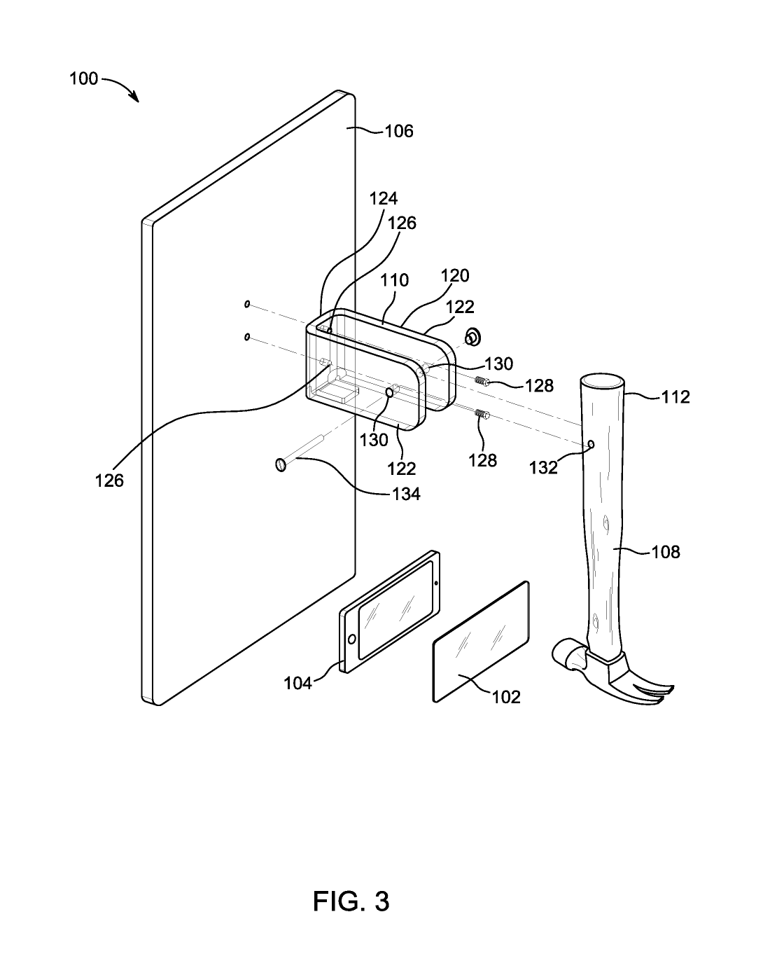

Referring now to FIG. 3, where like reference numerals depict like components, there is depicted an exploded view of the display 100. In an embodiment, the mounting assembly 110 comprises a bracket 120. In an embodiment, the bracket 120 is formed from plastic, acrylic, metal, wood or some other suitable material. The bracket 120 may be molded, including injection molding or heat molding. The bracket 120 comprises a pair of spaced apart sidewalls 122 extending forwardly from a back wall 124. Fasteners 128 may be utilized to secure the bracket 120 to the back support member 106. In particular, the back wall 124 may comprise bores 126 for receiving the fasteners 128. In an embodiment, the fasteners 128 are one of screws, bolts, nails, and staples. In an embodiment, the bracket 120 is secured to the back support member 106 using an adhesive. In an embodiment, the bracket 120 is integrally formed as part of the back support member 106, for example, the bracket 120 and the member 106 may be molded or formed as a single unitary piece.

The manner in which the striker 108 is installed onto the bracket 120 will now be described. Each of the sidewalls 122 comprises a bore 130. The arm 112 of the striker 108 also comprises a bore 132. A pin 134 may extend through the bores 130 and 132 to thereby pivotally mount the striker 108 to the bracket 120 as shown in FIGS. 1 and 2. It will be appreciated that the pin 134 allows the striker 108 to swing between a raised position and a lowered position.

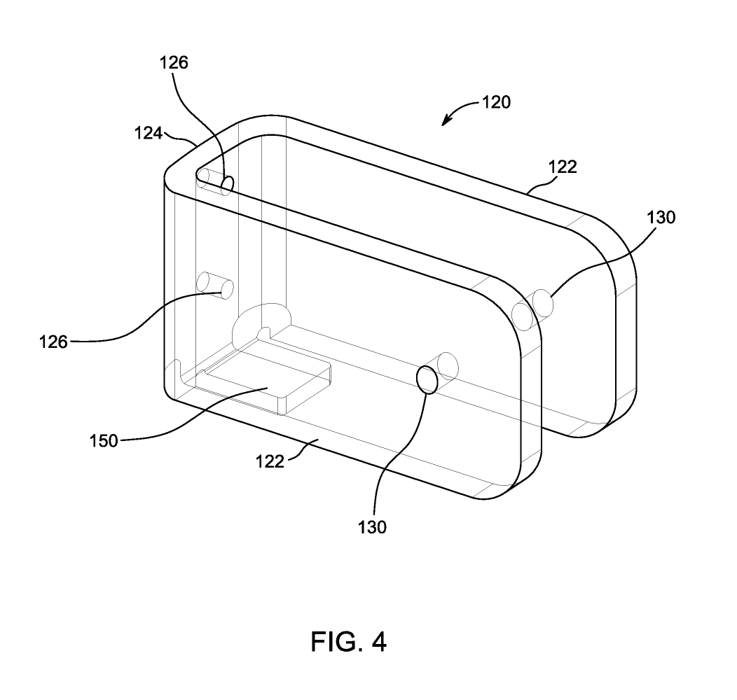

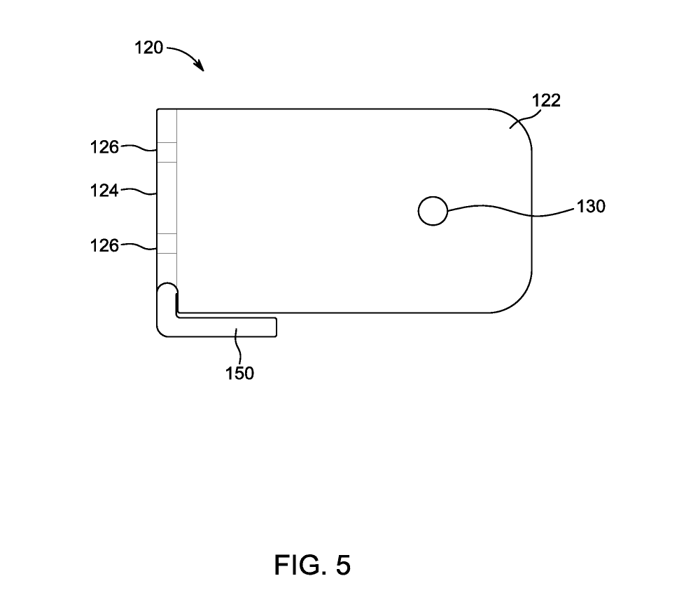

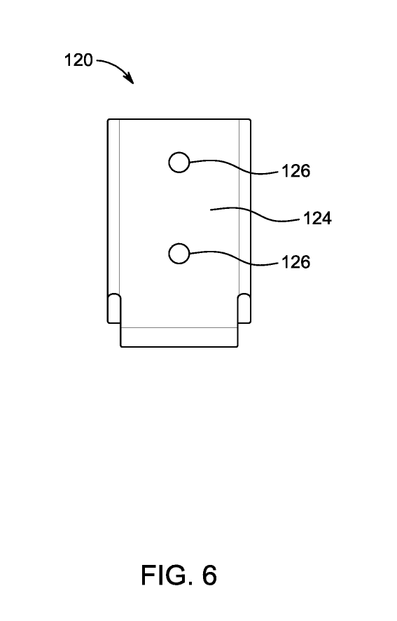

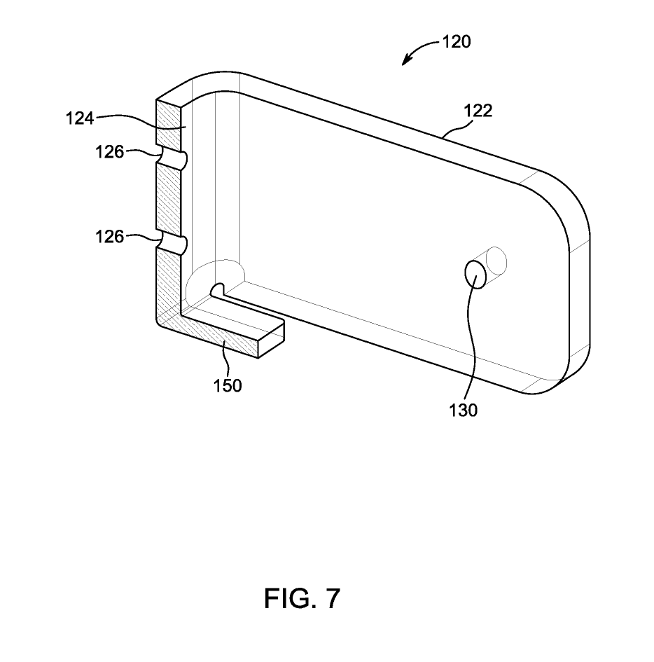

Referring now to FIGS. 4-7, further details of the bracket 120 will now be described. As mentioned, the bracket 120 includes a pair of spaced apart sidewalls 122 that extend from a back wall 124. The sidewalls 122 may comprise bores 130 for receiving a pin (not shown). Formed in the back wall 124 are bores 126. The bores 126 may receive fasteners (now shown) for mounting the bracket 120 to a support, such as a back support member.

The bracket 120 may further include a stop 150 extending from the back wall 124. It will be appreciated that the stop 150 limits movement of the striker 108 by contacting the arm 112 as shown in FIG. 2. In an embodiment, the stop 150 limits movement of the striker 108 such that it can swing no more than 110 degrees from the lowered position. In an embodiment, the stop 150 limits movement of the striker 108 to less than 100 degrees. In an embodiment, the stop 150 limits movement of the striker 108 to less than 95 degrees.

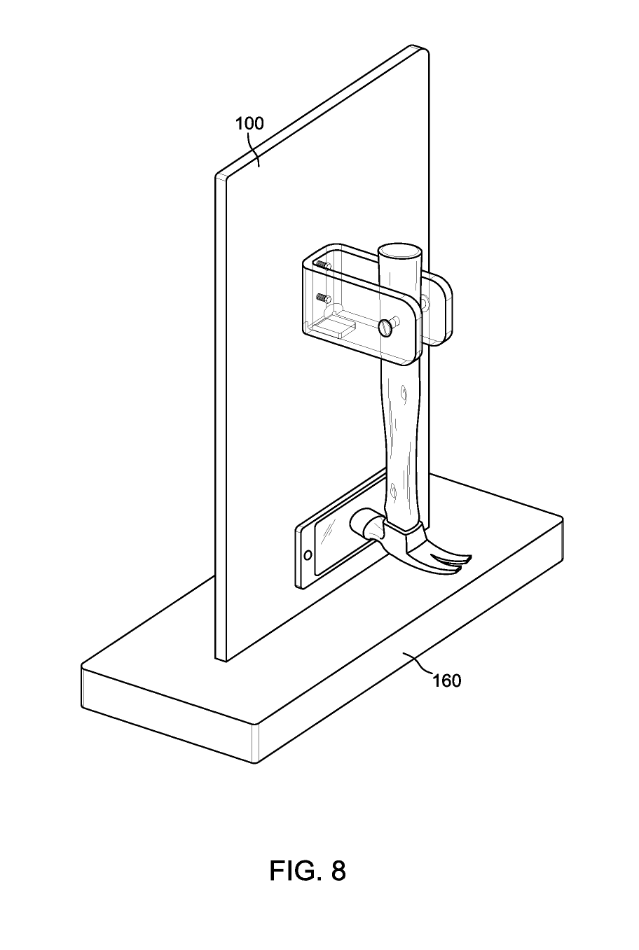

Referring now to FIG. 8, there is shown the display 100 mounted onto a stand 160 such that the display 100 may be used on a horizontal surface, such as a table. The display 100 may be mounted into a slot formed in the top surface of the stand 160. Alternatively, brackets may be utilized to secure the display 100 to the stand 160 or any other surface.

In operation, the display 100 allows a user to test the strength of a glass screen protector being offered for sale. For example, the display 100 may be placed adjacent a location where the glass screen protectors are offered for sale in a retail location. A user may lift the striker 108 from the lowered position to the raised position. The user may then release the striker 108 such that it free falls to strike a pre-positioned sample of the glass screen protector. The glass screen protector should remain intact after the impact. It will be appreciated that the use of the stop 150 prevents the user from raising the striker too far and causing injury to the user. Thus, the purpose of the stop 150 is not only to prevent breakage of the glass screen protector but also is employed out of safety concerns.

According to an embodiment of the present disclosure, the present invention provides an interactive advertising display assembly comprising: a back support member; a striker; a mounting assembly for mounting the striker to the back support member such that said striker is operable between a first position and a second position; a glass screen protector for a mobile electronic device disposed to receive an impact from said striker; wherein said striker is disposed above said glass screen protector when the striker is operated to the first position; wherein said striker delivers an impact to said glass screen protector when said striker is operated to the second position. In the previously described embodiment, the striker is a hammer. In the previously described embodiment, the striker comprises an arm. In the previously described embodiment, the mounting assembly pivotally mounts the striker to the back support member. In the previously described embodiment, the mounting assembly is configured and dimensioned to allow the striker to free fall between the first position and the second position. In the previously described embodiment, further comprising a stop configured and adapted to limit movement of the striker. In the previously described embodiment, wherein the mounting assembly comprises a bracket having a pair of spaced apart sidewalls and a pin extending between the sidewalls, wherein said pin passes through said striker. In the previously described embodiment, wherein the glass screen protector is mounted to said back support member. In the previously described embodiment, further comprising a stand for supporting said back support member in an upright position.

According to an embodiment of the present disclosure, the present invention provides an interactive advertising display assembly comprising: a back support member; a striker mounted to the back support member, said striker having an impact surface; a glass screen protector disposed to receive a strike from the impact surface of the striker; wherein the striker is operable between a raised position and a lowered position; wherein the striker is configured and adapted to free fall between the raised position and the lowered position such that the impact surface of the striker strikes the glass screen protector. In the previously described embodiment, further comprising a mounting assembly for mounting the striker to the back support member. In the previously described embodiment, wherein the striker is an off-the-shelf hammer. In the previously described embodiment, wherein the glass screen protector is installed onto a mobile electronic device. In the previously described embodiment, wherein the glass screen protector is installed onto a replica of a mobile electronic device. In the previously described embodiment, further comprising a stop to limit movement of the striker. In the previously described embodiment, further comprising a stand for the back support member.

According to an embodiment of the present disclosure, the present invention provides an interactive advertising display assembly comprising: a striker having an arm and an impact surface, the arm comprising a bore; a mounting assembly operable to secure the striker to a support; the mounting assembly comprising at least one bore; a pin; a glass screen protector; wherein said pin is mountable in the bore of the arm and the at least one bore of the mounting assembly such that the striker is operable between a raised position and a lowered position; wherein the striker is configured and adapted to free fall between the raised position and the lowered position such that the impact surface strikes the glass screen protector. In the previously described embodiment, wherein the striker is a hammer. In the previously described embodiment, wherein the mounting assembly comprises a bracket having a pair of spaced apart sidewalls. In the previously described embodiment, wherein the bracket is formed of one of metal, wood, plastic, acrylic and plexiglass.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An interactive advertising display assembly comprising:
a back support member;
a striker;
a mounting assembly for mounting the striker to the back support member such that said striker is operable between a first position and a second position; and
a screen protector for a mobile electronic device disposed to receive an impact from said striker;
wherein said striker is disposed above said screen protector when the striker is operated to the first position;
wherein said striker delivers an impact to said screen protector when said striker is operated to the second position.

2. The assembly of claim 1, wherein the striker is a hammer.

3. The assembly of claim 1, wherein the striker comprises an arm.

4. The assembly of claim 1, wherein the mounting assembly pivotally mounts the striker to the back support member.

5. The assembly of claim 1, wherein the mounting assembly is configured and dimensioned to allow the striker to free fall between the first position and the second position.

6. The assembly of claim 1, further comprising a stop configured and adapted to limit movement of the striker.

7. The assembly of claim 1, wherein the mounting assembly comprises a bracket having a pair of spaced apart sidewalls and a pin extending between the sidewalls, wherein said pin passes through said striker.

8. The assembly of claim 1, wherein the screen protector is mounted to said back support member.

9. The assembly of claim 1, further comprising a stand for supporting said back support member in an upright position.

10. An interactive advertising display assembly comprising:
a back support member;
a striker mounted to the back support member, said striker having an impact surface;
a screen protector disposed to receive a strike from the impact surface of the striker;
wherein the striker is operable between a raised position and a lowered position;
wherein the striker is configured and adapted to free fall between the raised position and the lowered position such that the impact surface of the striker strikes the screen protector.

11. The assembly of claim 10, further comprising a mounting assembly for mounting the striker to the back support member.

12. The assembly of claim 10, wherein the striker is an off-the-shelf hammer.

13. The assembly of claim 10, wherein the screen protector is installed onto a mobile electronic device.

14. The assembly of claim 10, wherein the screen protector is installed onto a replica of a mobile electronic device.

15. The assembly of claim 10, further comprising a stop to limit movement of the striker.

16. The assembly of claim 10, further comprising a stand for the back support member.

17. An interactive advertising display comprising:
a striker having an arm and an impact surface, the arm comprising a bore;
a mounting assembly operable to secure the striker to a support;
the mounting assembly comprising at least one bore;
a pin;
a screen protector;
wherein said pin is mountable in the bore of the arm and the at least one bore of the mounting assembly such that the striker is operable between a raised position and a lowered position;
wherein the striker is configured and adapted to free fall between the raised position and the lowered position such that the impact surface strikes the screen protector.

18. The display of claim 17, wherein the striker is a hammer.

19. The display of claim 17, wherein the mounting assembly comprises a bracket having a pair of spaced apart sidewalls.

20. The display of claim 17, wherein the screen protector is formed of one of glass, tempered glass, and a film.
